(19) United States
(12) Patent Application Publication
(10) Pub. No.: US 2022/0183115 A1
(43) Pub. Date: Jun. 9, 2022

(54) OVEN APPLIANCE WITH COOKWARE LOCATION AND EFFECTIVENESS DETECTION

(71) Applicant: Haier US Appliance Solutions, Inc., Wilmington, DE (US)

(72) Inventor: Peijian Yuan, Louisville, KY (US)

(21) Appl. No.: 17/111,601

(22) Filed: Dec. 4, 2020

(51) Int. Cl. H05B 6/06; F24C 7/06; F24C 7/08; H05B 6/12

(52) U.S. Cl. CPC H05B 6/062; F24C 7/067; H05B 2213/07; H05B 6/1245; H05B 2213/05; F24C 7/083

(57) ABSTRACT

A cooktop appliance includes a cooking surface configured for receipt of a cooking utensil and an induction heating element operable to inductively heat a load with a magnetic field. The induction heating element includes a coil. The cooktop appliance also includes a sensor. The sensor is operable to detect a location and an efficiency of the cooking utensil. The sensor may be positioned between the coil of the induction heating element and the cooking surface and/or may include a plurality of semi-circular loops spaced apart around a circumference of the coil.

### FIELD

The present subject matter relates generally to cooktop appliances and more particularly to cooktop appliances with an induction heating element and a related sensor.

### BACKGROUND

Induction cooking appliances are more efficient, have greater temperature control precision and provide more uniform cooking than other conventional cooking appliances. In conventional cooktop systems, an electric or gas heat source is used to heat cookware in contact with the heat source. This type of cooking is inefficient because only the portion of the cookware in contact with the heat source is directly heated. The rest of the cookware is heated through conduction that causes non-uniform cooking throughout the cookware. Heating through conduction takes an extended period of time to reach a desired temperature.

In contrast, induction cooking systems use electromagnetism which turns cookware of the appropriate material into a heat source. Such appropriate materials may include ferromagnetic materials in order to effectively capture the magnetic field produced by the induction cooking coil. Other materials, such as aluminum, will be very inefficient for cooking on an induction cooking system. A power supply provides a signal having a frequency to the induction coil. When the coil is activated a magnetic field is produced which induces a current on the bottom surface of the cookware. The induced current on the bottom surface then induces even smaller currents (Eddy currents) within the cookware thereby providing heat throughout the cookware.

However, when there is poor magnetic coupling between a cookware and the induction coil, e.g., due to cookware of inappropriate material and/or not centered on the induction element, undesirable operating conditions can occur and cooking performance may be impaired.

Accordingly, a cooktop appliance with features for avoiding such degraded cooking performance would be useful. In particular, a cooktop appliance with features for determining or verifying magnetic coupling, e.g., that a cooking utensil is correctly located on the induction element of the cooktop appliance and/or is a compatible material, would be particularly beneficial.

### BRIEF DESCRIPTION OF THE INVENTION

Aspects and advantages of the invention will be set forth in part in the following description, or may be apparent from the description, or may be learned through practice of the invention.

In an exemplary aspect of the present disclosure, a cooktop appliance is provided. The cooktop appliance includes a cooking surface configured for receipt of a cooking utensil and an induction heating element operable to inductively heat a load with a magnetic field. The induction heating element includes a coil. The cooktop appliance also includes a sensor positioned between the coil of the induction heating element and the cooking surface. The sensor is operable to detect a location and an efficiency of the cooking utensil.

In another exemplary aspect, a cooktop appliance is provided. The cooktop appliance includes a cooking surface configured for receipt of a cooking utensil and an induction heating element operable to inductively heat a load with a magnetic field. The induction heating element includes a coil. The cooktop appliance also includes a sensor operable to detect a location and an efficiency of the cooking utensil. The sensor includes a plurality of semi-circular loops spaced apart around a circumference of the coil.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a range having a cooktop appliance according to one or more exemplary embodiments of the present subject matter.

FIG. 2 provides a schematic view of the cooktop appliance of FIG. 1 with an induction heating element of the cooktop appliance shown heating a cooking utensil on the induction heating element.

FIG. 3 provides a schematic view of a detection system for an induction heating element.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

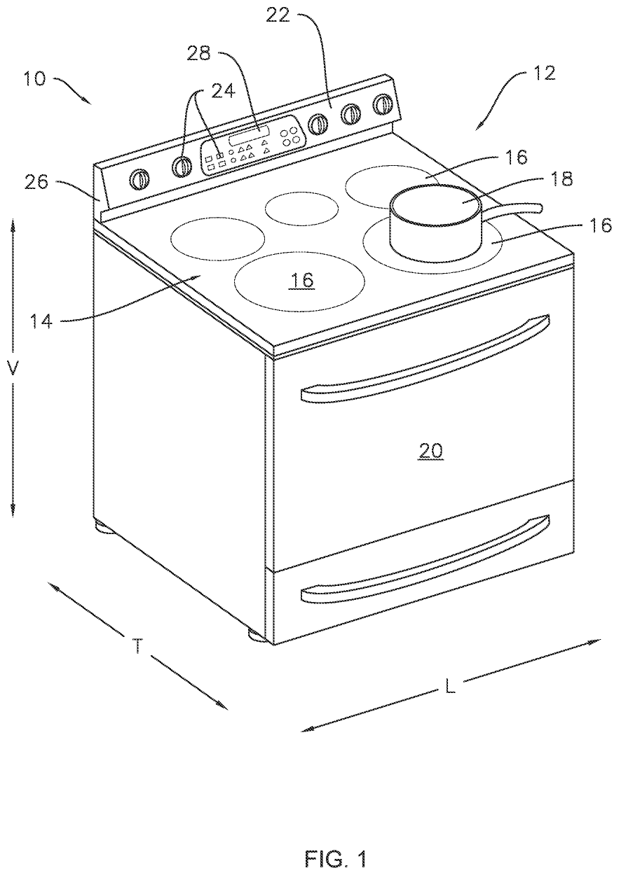

FIG. 1 provides a perspective view of a range appliance, or range 10, including a cooktop 12. Range 10 is provided by way of example only and is not intended to limit the present subject matter to the arrangement shown in FIG. 1. Thus, the present subject matter may be used with other range 10 and/or cooktop 12 configurations, e.g., double oven range appliances, standalone cooktop appliances, cooktop appliances without an oven, etc.

A cooking surface 14 of cooktop appliance 12 includes a plurality of heating elements 16. The heating elements 16 are generally positioned at, e.g., on or proximate to, the cooking surface 14. In certain exemplary embodiments, cooktop 12 may be an induction cooktop with induction heating elements mounted below cooking surface 14. For the embodiment depicted, the cooktop 12 includes five heating elements 16 spaced along cooking surface 14. However, in other embodiments, the cooktop appliance 12 may include any other suitable shape, configuration, and/or number of heating elements 16. Each of the heating elements 16 may be the same type of heating element 16, or cooktop appliance 12 may include a combination of different types of heating elements 16. For example, in various embodiments, the cooktop appliance 12 may include any other suitable type of heating element 16 in addition to the induction heating element, such as a resistive heating element or gas burners, etc.

As shown in FIG. 1, a cooking utensil 18, such as a pot, pan, or the like, may be placed on a heating element 16 to heat the cooking utensil 18 and cook or heat food items placed in cooking utensil 18. Range appliance 10 also includes a door 20 that permits access to a cooking chamber (not shown) of range appliance 10, e.g., for cooking or baking of food items therein. A control panel 22 having controls 24 permits a user to make selections for cooking of food items. Although shown on a backsplash or back panel 26 of range appliance 10, control panel 22 may be positioned in any suitable location. Controls 24 may include buttons, knobs, and the like, as well as combinations thereof, and/or controls 24 may be implemented on a remote user interface device such as a smartphone, tablet, etc. As an example, a user may manipulate one or more controls 24 to select a temperature and/or a heat or power output for each heating element 16. The selected temperature or heat output of heating element 16 affects the heat transferred to cooking utensil 18 placed on heating element 16. The control panel 22 may also include a display 28.

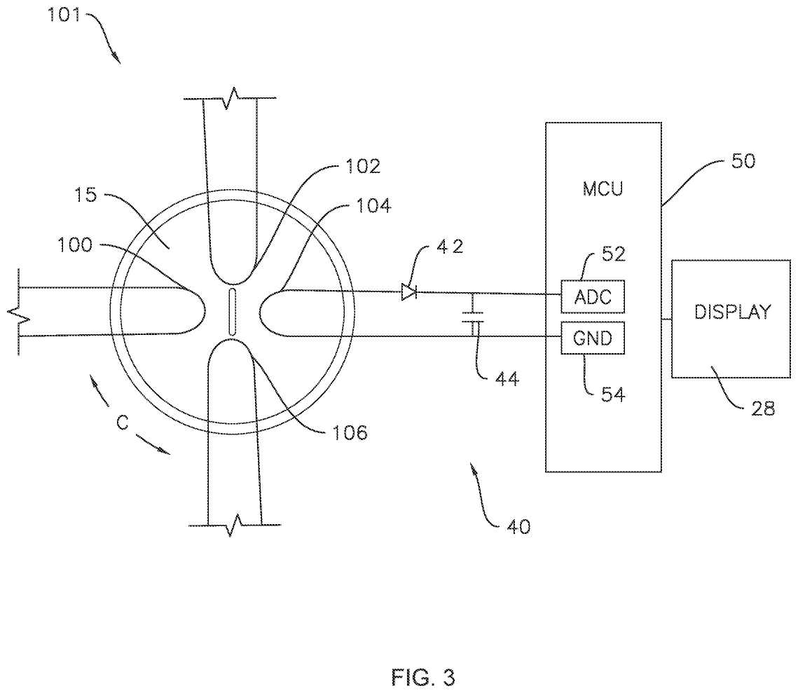

The cooktop appliance 12 includes a control system for controlling one or more of the plurality of heating elements 16. Specifically, the control system may include a controller 50 (FIG. 3) operably connected to the control panel 22 and the controls 24 and display 28 thereof. The controller 50 may be operably connected to each of the plurality of heating elements 16 for controlling a heating level each of the plurality of heating elements 16 in response to one or more user inputs received through the control panel 22 and controls 24. The controller 50 may also provide output to the display 28, such as an indication of a selected power level, which heating element(s) 16 is or are activated, etc.

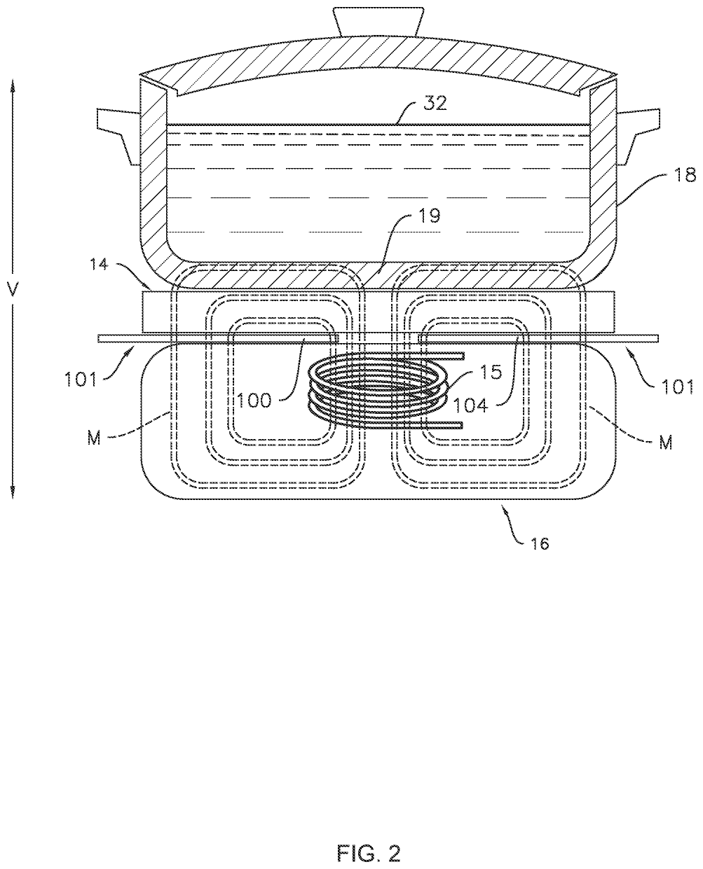

FIG. 2 provides a schematic view of induction heating element 16 shown heating a cooking utensil 18 supported on cooking surface 14. Induction heating element 16 includes a Lenz coil or wire 15. As will be understood by those skilled in the art, cooktop appliance 10 can supply a current to Lenz coil 15. As such, current passes through Lenz coil 15 and Lenz coil 15 generates a magnetic field (shown with dashed lines M). The magnetic field can be a high frequency circulating magnetic field. As shown in FIG. 2, Lenz coil 15 can be oriented such that magnetic field M is directed towards and through cooking surface 14 to cooking utensil 18. In particular, when magnetic field M penetrates cooking utensil 18, magnetic field M induces a circulating electrical current within cooking utensil 18, e.g., within a bottom wall 19 of cooking utensil 18. The material properties of cooking utensil 18 restrict a flow of the induced electrical current and convert the induced electrical current into heat within cooking utensil 18. As cooking utensil 18 heats up, contents 32 of cooking utensil 18 contained therein heat up as well. In such a manner, induction heating element 16 can cook contents 32 of cooking utensil 18.

In some embodiments, e.g., as illustrated in FIG. 2, the cooktop appliance 10 may also include a sensor 101 positioned between the Lenz coil 15 and the cooking utensil 18, such as between the Lenz coil 15 and the cooking surface 14. For example, the sensor 101 may be located above the Lenz coil 15 and below the cooking utensil 18 along the vertical direction V, such as below the cooking surface 14 along the vertical direction V. In at least some embodiments, the sensor 101, or at least a portion thereof, may be positioned directly above the coil 15 along the vertical direction V, as may be seen in FIGS. 2 and 3. As will be described in more detail below, the sensor 101 may be operable to detect a location and an efficiency of the cooking utensil 18.

Referring now to FIG. 3, the sensor 101 may include a plurality of semi-circular loops, such as four loops, e.g., a first loop 100, a second loop 102, a third loop 104, and a fourth loop 106. The plurality of semi-circular loops may be spaced apart around a circumference of the coil 15, e.g., the coil 15 may define a circumferential direction C and the loops 100, 102, 104, and 106 may be spaced apart along the circumferential direction C. In other embodiments, the plurality of semi-circular loops may include any suitable number of loops, such as two or three loops, or more than four loops. In some embodiments, the plurality of semi-circular loops may be equally spaced around the circumference of the coil 15. For example, in embodiments such as the example embodiment illustrated in FIG. 3 where the plurality of semi-circular loops includes four semi-circular loops 100, 102, 104, and 106, each loop of the four semi-circular loops 100, 102, 104, and 106 may be spaced apart from adjacent semi-circular loops of the plurality of semi-circular loops by about ninety degrees.

As mentioned above, at least a portion of the sensor 101 may be positioned directly above the coil 15, in particular, the loops of the sensor may be positioned directly above the coil 15 along the vertical direction V, as may be seen in FIG. 3. It will be recognized that the loops of the sensor 101 are coupled together, although the connecting portions extending from the first loop 100, the second loop 102, and the fourth loop 106 are omitted from FIG. 3 for clarity. The sensor 101, including all of the semi-circular loops thereof, e.g., all four loops 100, 102, 104, and 106 in the illustrated embodiment, may be coupled to the controller 50 of the oven appliance 100.

As illustrated in FIG. 3, in at least some embodiments, the controller 50 may be or include a microcontroller unit (MCU). The sensor 101 may be connected to the controller 50 at an Analog-to-Digital Converter (ADC) input 52 and at a grounded (GND) input 54 of the controller 50. The sensor 101 and the controller 50 may be parts of a circuit 40. As shown in FIG. 3, in at least some embodiments, the circuit 40 may include a diode 42 and a capacitor 44. For example, the diode 42 may be coupled to (in-line with) a first branch of the sensor 101 which is connected to the ADC input 52 and the capacitor 44 may bridge between the first branch of the sensor 101 and a second branch of the sensor 101 which is connected to the GND input 54. The circuit 40 may advantageously be a relatively simple circuit, e.g., no amplifier is included or required, which reduces cost and complexity of the oven appliance 100. For example, the circuit 40 may include only the one diode 42 and only the one capacitor 44.

In some embodiments, each semi-circular loop of the plurality of semi-circular loops may be formed of a single copper wire. For example, the first loop 100 may be formed of a single copper wire, the second loop 102 may be formed of a second single copper wire, the third loop 104 may be formed of a third single copper wire, and the fourth loop 106 may be formed of a fourth single copper wire. Thus, each loop of the plurality of semi-circular loops may be a flat loop with both ends of each loop parallel to and co-planar with each other. Additionally, in some embodiments, e.g., as illustrated in FIG. 2, the plurality of semi-circular loops may be oriented parallel to the cooking surface 14. Each semicircular copper wire loop 100, 102, 104, and 106 can generate enough voltage for the ADC input 52, such that no amplifier is needed or included in the circuit 40, as mentioned above. At the same time, the sensitivity value of the sensor 101 may be determined by the coverage area of the plurality of semi-circular loop 100, 102, 104, and 106.

In operation, the plurality of loops, e.g., the four semi-circular loops 100, 102, 104, and 106, of the sensor 101 which are positioned above the induction coil 15 draw energy from the coil 15. The energy value depends on the conversion coefficient. Different materials of the cooking utensil 18 and positions of the cooking utensil 18 will affect the conversion coefficient. The energy in each loop of the plurality of loops 100, 102, 104, and 106 is rectified and sent to the controller 50 via the ADC input 52. Comparison of the energy of the plurality of loops 100, 102, 104, and 106 can determine the relative position of the cooking utensil 18. In addition, the measured energy may be compared to a reference energy value that corresponds to a standard iron pan to know the efficiency of the cooking utensil 18. For example, the reference energy value may be stored in a memory of the controller 50. In embodiments where the plurality of loops 100, 102, 104, and 106 are distributed in different directions, e.g., in four different directions as in the example embodiment illustrated in FIG. 3, comparing the output values of the loops of the plurality of loops 100, 102, 104, and 106 can determine the position of the cooking utensil 18. For example, in the embodiment illustrated in FIG. 3, if the energy of the fourth loop 106 is higher than the energy of the second loop 102, then it may be determined or inferred that the cooking utensil 18 is not centered on (e.g., concentric with) the induction heating element, e.g., in this example the cooking utensil 18 may be offset toward the front of the cooktop (assuming that the bottom of the page in FIG. 3 corresponds to the front of the cooktop) when the energy of the fourth loop 106 is higher than the energy of the second loop 102.

In some embodiments, the cooktop appliance 10 may be configured to display a position of the cooking utensil 18 and an efficiency of the cooking utensil 18 at the user interface 22, such as on the display 28. In various embodiments, the display 28 may be or include a screen such as an LCD screen or an LED array, among other suitable screen types. For example, an LCD screen may be advantageous for displaying the position and efficiency of the cooking utensil 18. However, it should be recognized that LED and other digital screens can also display the position and efficiency of the cooking utensil 18.

In some embodiments, the cooktop appliance 10 may be configured to provide a user notification or alert when the cooking utensil 18 is not aligned, e.g., concentric, with the induction heating element and/or when the cooking utensil 18 is not effective, e.g., is not of a suitable material, such as does not include sufficient iron content, for magnetic induction heating. The user notification may include a visual notification, such as an indication of the position of the cooking utensil 18 relative to the induction heating element 16 on the display 28, as described above. The user notification may also or instead include an audible notification such as an alarm. The alarm sound may be any suitable sound, such as a beep, chime, etc. The alarm sound may also tell the user the offset of the cooking utensil 18 from the best position. For example, the alarm sound may increase in volume, increase the speed of a series of sounds, change tone or pitch of the sound, or use a different sound, as the offset, e.g., the distance between the center of the cooking utensil 18 and the center of the coil 15, increases. For example, the best position may be generally concentric with the heating element 16, where “generally concentric” includes a maximum offset between the center of the utensil 18 and the center of the heating element 16 in any direction of 10% of the diameter of the heating element 16 or less.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooktop appliance, comprising:
a cooking surface configured for receipt of a cooking utensil;
an induction heating element operable to inductively heat a load with a magnetic field, the induction heating element comprising a coil; and
a sensor positioned between the coil of the induction heating element and the cooking surface, the sensor operable to detect a location and an efficiency of the cooking utensil.

2. The cooktop appliance of claim 1, wherein the sensor is positioned above the coil along a vertical direction and below the cooking surface along the vertical direction.

3. The cooktop appliance of claim 1, wherein the sensor is positioned directly above the coil along a vertical direction.

4. The cooktop appliance of claim 1, wherein the sensor comprises a plurality of semi-circular loops spaced apart around a circumference of the coil.

5. The cooktop appliance of claim 4, wherein each semi-circular loop of the plurality of semi-circular loops is formed of a single copper wire.

6. The cooktop appliance of claim 4, wherein the loops of the plurality of semi-circular loops are equally spaced around the circumference of the coil.

7. The cooktop appliance of claim 4, wherein the plurality of semi-circular loops comprises four semi-circular loops, with each of the four semi-circular loops spaced apart from adjacent semi-circular loops of the plurality of semi-circular loops by about ninety degrees.

8. The cooktop appliance of claim 4, wherein the plurality of semi-circular loops are oriented parallel to the cooking surface.

9. The cooktop appliance of claim 1, further comprising a controller connected to the sensor whereby the controller receives a signal from the sensor, the signal indicative of the detected location and efficiency of the cooking utensil, and wherein the controller is connected to the sensor without an amplifier.

10. The cooktop appliance of claim 1, further comprising a circuit, the circuit comprising the sensor, a controller of the cooktop appliance connected to the sensor, only one diode and only one capacitor.

11. A cooktop appliance, comprising:
a cooking surface configured for receipt of a cooking utensil;
an induction heating element operable to inductively heat a load with a magnetic field, the induction heating element comprising a coil; and
a sensor operable to detect a location and an efficiency of the cooking utensil, the sensor comprising a plurality of semi-circular loops spaced apart around a circumference of the coil.

12. The cooktop appliance of claim 11, wherein the sensor is positioned between the coil of the induction heating element and the cooking surface

13. The cooktop appliance of claim 11, wherein the sensor is positioned directly above the coil along a vertical direction.

14. The cooktop appliance of claim 11, wherein the sensor comprises a plurality of semi-circular loops spaced apart around a circumference of the coil.

15. The cooktop appliance of claim 14, wherein each semi-circular loop of the plurality of semi-circular loops is formed of a single copper wire.

16. The cooktop appliance of claim 14, wherein the loops of the plurality of semi-circular loops are equally spaced around the circumference of the coil.

17. The cooktop appliance of claim 14, wherein the plurality of semi-circular loops comprises four semi-circular loops, with each of the four semi-circular loops spaced apart from adjacent semi-circular loops of the plurality of semi-circular loops by about ninety degrees.

18. The cooktop appliance of claim 14, wherein the plurality of semi-circular loops are oriented parallel to the cooking surface.

19. The cooktop appliance of claim 11, further comprising a controller connected to the sensor whereby the controller receives a signal from the sensor, the signal indicative of the detected location and efficiency of the cooking utensil, and wherein the controller is connected to the sensor without an amplifier.

20. The cooktop appliance of claim 11, further comprising a circuit, the circuit comprising the sensor, a controller of the cooktop appliance connected to the sensor, only one diode and only one capacitor.
